(19) United States
(12) Patent Application Publication
(10) Pub. No.: US 2009/0159753 A1
(43) Pub. Date: Jun. 25, 2009

(54) MOMENTUM MANAGEMENT SYSTEM FOR REACTION WHEEL BY USING NULL SPACE VECTOR AND METHOD

(75) Inventors: Jo Ryeong Yim, Daejeon (KR); Shi Hwan Oh, Daejeon (KR); Seon Ho Lee, Daejeon (KR); Hyun Ho Seo, Daejeon (KR); Yong Bok Kim, Daejeon (KR); Hye Jin Lee, Daejeon (KR); Hong Taek Choi, Daejeon (KR); Ki Lyuk Yong, Deajeon (KR)

Correspondence Address: EDWARDS ANGELL PALMER & DODGE LLP, P.O. BOX 55874, BOSTON, MA, 02205, US

(73) Assignee: KOREA AEROSPACE RESEARCH INSTITUTE, Daejeon (KR)

(21) Appl. No.: 12/341,393

(22) Filed: Dec. 22, 2008

(30) Foreign Application Priority Data
Dec. 24, 2007 (KR) 10-2007-136684

(51) Int. Cl. B64G 1/28

(52) U.S. Cl. 244/165

(57) ABSTRACT

A reaction wheel momentum management method using a null space vector is provided. In accordance with this method, when any one of at least four reaction wheels used for triaxial control is made unavailable or degraded, a degraded wheel is used as long as possible for improving the mobility of the behavior of a satellite. The method provides momentum management for an N-number of reaction wheels W₁, W₂, . . . WN used for triaxial control of a satellite B by using a null space vector, and includes the steps of: (S10) measuring the current speed and momentum of the wheels in real time and comparing the measured current speed and momentum with a preset maximum speed and momentum; (S20) calculating a zero torque Tn based on a difference between the current speed and momentum and the maximum speed Wi,max and momentum Hi,max by the step (S10); (S30) adding the zero torque acquired by the step (S20) to a wheel torque Ta required for controlling and stabilizing the attitude of the satellite; and (S40) making the wheels reach an optimum bias momentum state by using the input torque of the wheels acquired by the step (S30).

### CROSS-REFERENCE TO RELATED APPLICATION

This application claims under 35 U.S.C. §119(a) the benefit of Korean Patent Application No. 10-2007-136684 filed Dec. 24, 2007, the entire contents of which are incorporated herein by reference.

### TECHNICAL FIELD

The present invention relates to a reaction wheel momentum management method using a null space vector, and more particularly, to a reaction wheel momentum management method using a null space vector, which can normalize the speed of wheels at an optimum bias speed, rather than at a zero speed, even when an originally planned maximum momentum cannot be provided because of degradation of any one of four or more reaction wheels, or even when the maximum momentums of wheels to be used together are different from each other.

### BACKGROUND ART

Since an artificial satellite circling the earth is always exposed to the space environment, the effect of disturbances caused by the space environment should be controlled in order to successfully perform given tasks (communication, broadcasting, earth and space observation, etc.).

As a drive unit used for such control, a thruster and a reaction wheel are mainly used. The thruster is a device that obtains thrust and torque by using a propellant mounted on an artificial satellite, and thus the thruster is connected directly with the life span of an artificial satellite. The reaction wheel is a device that obtains torque by using electric power. Therefore, the reaction wheel is mainly used to perform an attitude control since it can be always driven depending on the life span of a solar panel.

To be more specific, a method using a thruster utilizes a large amount of fuel, and hence has a critical effect on the life span of the satellite, thus requiring a method capable of reducing the use of fuel as much as possible. Accordingly, in order to provide a required torque by a method using no fuel, a magnetic torquer or the like may be used. However, it is not easy for the magnetic torquer to provide a required torque amplitude because the amplitude of its available torque is small and it is dependent on the earth magnetic field of the place where the satellite is located. As a result, a reaction wheel that can produce a higher torque than the magnetic torquer does is used as a primary drive unit for attitude control.

Although three orthogonal reaction wheels are generally required for triaxial attitude control, typically four or more reaction wheels are arranged in a pyramid configuration with a skew angle, so as to be used when any one of three orthogonal wheels is unavailable. When four or more wheels are used for triaxial control, one or more null space vector exists. In conventional methods, the speed of reaction wheels is normalized at a constant bias speed by using this null space vector, and this does not affect the attitude of the satellite because a zero torque is applied to the wheels by using a null space vector.

However, if one of the wheels is made unavailable or degraded and the wheel with the problem is not used at all, no null space vector exists, thus making it impossible to normalize the speed of the wheels at an optimum bias speed. Therefore, a zero momentum state is satisfied only when the three wheels have a zero speed and do not rotate. By the way, with the zero speed, the direction of the wheels frequently changes, thus increasing the possibility of degradation of a normal wheel. Moreover, if the direction of the wheels changes at a zero speed, this acts as disturbance to the satellite due to a frictional force of the wheels and affects the attitude of the satellite as well. Although the concept of use of a null space vector is already known, no concrete method for making a degraded reaction wheel as available as possible is specified.

The following is an explanation about a conventional zero torque calculation method.

First, a satellite B and an N-number of reaction wheels W₁, W₂, . . . W_{N} will be considered for sake of explanation. At least four wheels are used to control three axes, and therefore, the momentum of each wheel can be expressed in three axes by using a wheel steering matrix as follows:

$$[ \begin{matrix}{H}_{x} \\ {H}_{y} \\ {H}_{z}\end{matrix} ] = C [ \begin{matrix}{H}_{w , 1} \\ ⋮ \\ {H}_{w , N}\end{matrix} ] \qquad Eq . ( 1 )$$

wherein C denotes a 3×N matrix, H_{w} indicates the angular momentum of wheels; and Hₓ, H_{y}, and H_{z} indicate the angular momentum of each axis of the satellite. If N>3, C has more columns than rows, and hence an M=N−3-number of column vectors V1, . . . Vm can be generated. This is referred to as a null space vector. Then, the conventional method is to normalize the speed of the wheels at an optimum speed by using this null space vector. If the torque of the wheels generated in the normalization of the speed of the wheels is changed to a zero torque and the zero torque is applied as an input torque to the wheels, along with a torque required for attitude control, attitude stabilization can be achieved without affecting the momentum of the satellite. This can be expressed by the following equations in the order of calculation:

1. The optimized bias momentum of the wheels is referred to as Hcmd, and the difference between Hcmd and the current momentum of the wheels is referred to as ΔHw;

2. Then, a PI controller is designed to obtain a wheel torque Tw required for normalizing the speed of the wheels to an optimum speed;

3. By this, the following equation can be obtained as:

Tₙ=[C⁻¹C−I]T_{w} Eq. (2)

where Tn is a zero torque of the wheels obtained by using a null space vector, which does not affect the satellite; and

4. By adding this torque to a torque command value Ta which is required for the attitude control of the satellite, that is, which has an effect on a change in the attitude of the satellite, a total torque input value can be calculated as follows:

T_{cmd}=Tₐ+Tₘ Eq. (3)

As can be seen from the above, the conventional method is used for normalizing the speed of the wheels.

The above information disclosed in this Background Art section is only for enhancement of understanding of the background of the invention and therefore it may contain information that does not form the prior art that is already known in this country to a person of ordinary skill in the art.

### SUMMARY

It is, therefore, an object of the present invention to provide a reaction wheel momentum management method using a null space vector, which can stably maintain the attitude of a satellite in a normal condition while maintaining the speed of wheels at a constant bias speed by using both of reaction wheels having normal performance and degraded reaction wheels.

In accordance with the present invention, there is provided a momentum management method for an N-number of reaction wheels W₁, W₂, . . . W_{N} used for triaxial control of a satellite B by using a null space vector, including the steps of: (S10) measuring a current speed and momentum of the wheels in real time and comparing the measured current speed and momentum with a preset maximum speed and momentum; (S20) calculating a zero torque Tn based on a difference between the current speed and momentum and the maximum speed Wi,max and momentum Hi,max by the step (S10); (S30) adding the zero torque acquired by the step (S20) to a wheel torque Ta required for controlling and stabilizing the attitude of the satellite; and (S40) making the wheels reach an optimum bias momentum state by using an input torque of the wheels acquired by the step (S30).

### BRIEF DESCRIPTION OF THE DRAWINGS

The above and other objects and features of the present invention will become apparent from the following description of preferred embodiments, given in conjunction with the accompanying drawings, in which:

FIG. 1 is an illustration of the mobility of a behavior according to the prior art; and

FIG. 2 is an illustration of the mobility of a behavior in accordance with a reaction wheel momentum management method using a null space vector of the present invention.

### DETAILED DESCRIPTION

Hereinafter, preferred embodiments of a reaction wheel momentum management method using a null space vector in accordance with the present invention will be described in detail with reference to the accompanying drawings.

The present invention can be used to normalize the speed of wheels at an optimum bias speed, rather than at a zero speed, even when an originally planned maximum momentum cannot be provided because of degradation of any one of four or more reaction wheels used for a satellite, or even when the maximum momentums of wheels to be used together are different from each other. When one or more wheels reach the maximum momentum, the momentum of the corresponding wheel does not increase anymore and thus cannot produce a torque. The merits of the present invention are that a zero torque of a wheel is used to eliminate a required torque amount of the corresponding wheel and exert no effect on the attitude of a satellite, and the mobility of the attitude control of the satellite can be improved by using the performances of other wheels as much as possible. The present invention will be described below in the order of calculation and application.

(S10) Comparison of speed and momentum

The maximum speed of each wheel is denoted by Wi,max, and the maximum momentum is denoted by Hi,max. Then, it is judged whether the speed or momentum of wheels reaches a given maximum value or not by monitoring the current speed or momentum of the wheels and comparing them with one another. That is, a zero torque calculation method is dependent on whether the current speed and momentum are consistent with the maximum speed and the maximum momentum.

(S20) Calculation of zero torque if speed and momentum do not reach maximum value (That is, current speed and momentum are smaller than maximum speed and maximum momentum)

(S21) A PI controller is designed to acquire a wheel torque Tw required for normalizing the speed of a wheel to an optimum speed.

(S22) By this, the following equation can be obtained:

Tₙ=[C⁻¹C−I]T_{w} Eq. (2)

where Tn is a zero torque of the wheels derived by using a null space vector, which does not affect the satellite.

(S23) By adding this torque to a torque command value Ta which is required for the attitude control of the satellite, i.e., which has an effect on a change in the attitude of the satellite, a total torque input value to the wheels can be calculated as follows:

T_{cmd}=Tₐ+Tₙ Eq. (3)

(S30) Calculation of zero torque if current speed and momentum reach maximum value

(S31) A wheel torque Tₐ=[T_{a,1}, . . . T_{a,N}]^{T} required for controlling and stabilizing the attitude of the current satellite is used as an input value, and then a null vector Vi is calculated by using the aforementioned wheel steering matrix C. This means that once the layout of the wheels is determined, only one calculation is required. If there are four wheels, one null vector V exists.

(S32) When the torque of the wheel that has reached the maximum momentum is Ta,i, the Tn,i value is selected such that Tcmd,i of the corresponding wheel becomes zero, and then a zero torque to be added to the wheel is calculated by:

Tₐ=−T_{a,i}·V Eq. (4)

If there are four wheels, a zero vector V in the layout state where a skew angle is formed generally is as follows:

V=[+1−1+1−1]^{T} Eq. (5)

or

V=[−1+1−1+1]^{T} Eq. (6)

Accordingly, for example, when four wheels are used, if the first wheel reaches the maximum momentum, the following equation is obtained as:

T_{a,1}=[−T_{a,1},+T_{a,1},−T_{a,1},+T_{a,1}]^{T} Eq. (7)

As a result, a torque command value to be inputted into the wheels is as follows:

$$\begin{matrix}{T}_{cmd} = {T}_{a} + {T}_{n} \\ = [ \begin{matrix}{T}_{a , 1} \\ {T}_{a , 2} \\ {T}_{a , 3} \\ {T}_{a , 4}\end{matrix} ] + [ \begin{matrix}- {T}_{a , 1} \\ + {T}_{a , 1} \\ - {T}_{a , 1} \\ + {T}_{a , 1}\end{matrix} ] \\ = [ \begin{matrix}0 \\ {T}_{a , 2} + {T}_{a , 1} \\ {T}_{a , 3} - {T}_{a , 1} \\ {T}_{a , 4} + {T}_{a , 1}\end{matrix} ]\end{matrix} \qquad Eq . ( 8 )$$

(S33) The control and stabilization of the attitude of the satellite is performed by receiving Tcmd and operating the wheels.

Even if a degraded wheel or a wheel that has reached the maximum momentum is not the first wheel, Tn is calculated by using −Ta,i of the corresponding wheel such that Tcmd,i becomes zero like in the above Eq. (8).

The above-stated procedure is repetitively performed for controlling and stabilizing the attitude of the satellite, and the speed of the wheels is normalized at an optimized speed.

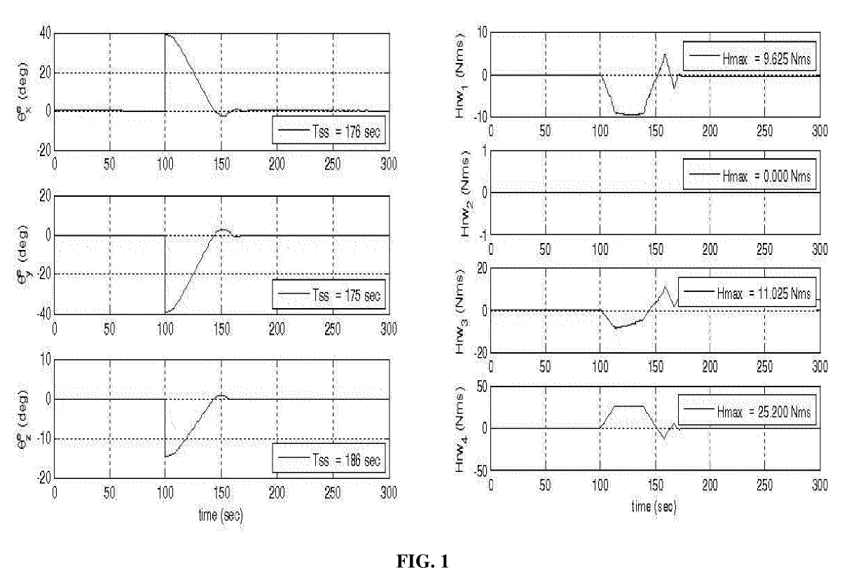

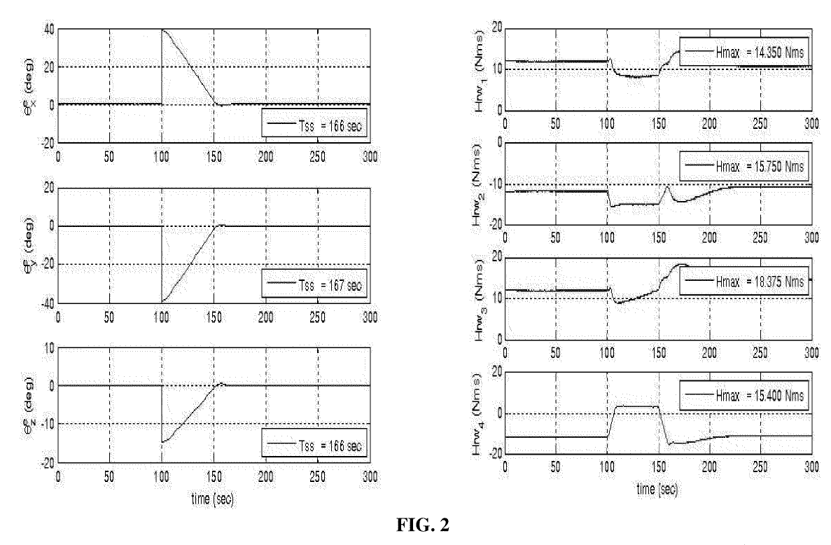

In case of using the prior art method alone, if three wheels are used after the use of four wheels, the same result as in FIG. 1 is obtained. For example, in FIG. 1, a degradation of the second wheel is detected and the use of the wheel is stopped, and, in this case, the speed of all the wheels used is normalized to a zero speed. As a result of performing a behavior at about 60 degrees for 100 seconds, it takes about 86 seconds for attitude control and stabilization. On the other hand, FIG. 2 shows a result of the assumption that a wheel whose momentum is normal is available up to 26 Nm but only the second wheel is available up to 15 Nm by using the method suggested in the present invention. The speed of the reaction wheels is normalized to 12.5 Nm, which is a momentum having an optimum speed of about 300 RPM. Similarly to FIG. 1, as a result of performing a behavior at about 60 degrees for 100 seconds, it takes about 67 seconds for attitude control and stabilization. By comparison with the result of FIG. 1, it can be seen that, if the present method is used, the mobility of the behavior of the satellite is improved by using a degraded wheel as long as possible.

In accordance with the reaction wheel momentum management method using a null space vector of the present invention, a zero torque of a wheel is calculated in a simple manner while using this method along with a prior art method, thus eliminating a required torque amount of the corresponding wheel and exerting no effect on the attitude of a satellite, and the mobility of the attitude control of the satellite can be improved compared to when using a restricted wheel by using the performances of other wheels as much as possible.

While the invention has been shown and described with respect to the preferred embodiments, it will be understood by those skilled in the art that various changes and modification may be made without departing from the spirit and scope of the invention as defined in the following claims.

What is claimed is:

1. A momentum management method for an N-number of reaction wheels W₁, W₂, . . . , W_{N} used for triaxial control of a satellite B by using a null space vector, comprising the steps of:
(S10) measuring a current speed and momentum of the wheels in real time and comparing the measured current speed and momentum with a preset maximum speed and momentum;
(S20) calculating a zero torque Tn based on a difference between the current speed and momentum and the maximum speed Wi,max and momentum Hi,max by the step (S10);
(S30) adding the zero torque acquired by the step (S20) to a wheel torque Ta required for controlling and stabilizing the attitude of the satellite; and
(S40) making the wheels reach an optimum bias momentum state by using an input torque of the wheels acquired by the step (S30).

2. The method of claim 1, wherein, in the zero torque calculating step (S20), if the current speed and momentum do not reach the maximum value, the momentum of each wheel is expressed in three axes by using a wheel steering matrix as in the following equation (1):
$$[ \begin{matrix}{H}_{x} \\ {H}_{y} \\ {H}_{z}\end{matrix} ] = C [ \begin{matrix}{H}_{w , 1} \\ ⋮ \\ {H}_{w , N}\end{matrix} ] \qquad Eq . ( 1 )$$
wherein C denotes a 3×N matrix, H_{w} indicates the angular momentum of wheels; and Hₓ, H_{y}, and H_{z} indicate the angular momentum of each axis of the satellite, and
a PI controller is designed to obtain a wheel torque Tw required for normalizing the speed of the wheels to an optimum speed, and a zero torque is calculated by the following equation (2):
Tₙ=[C⁻¹C−I]T_{w} Eq. (2)
wherein the zero torque is added to a torque command value Ta which has an effect on a change in the attitude of the satellite by the following equation (3), to thereby calculate an optimum bias momentum:
T_{cmd}=Tₐ+Tₙ Eq. (3)

3. The method of claim 1, wherein, in the zero torque calculating step (S20), if the current speed and momentum reach a maximum value, a wheel torque Ta,i required for attitude control and stabilization of the satellite of the wheel whose speed and momentum has reached the maximum value is multiplied by a null space vector to generate a zero torque, and
the zero torque is added to a torque Ta required for attitude control to obtain a torque Tcmd inputted to the reaction wheels, to thereby calculate an optimum bias momentum.

4. The method of claim 3, wherein, in the zero torque generating step, a wheel torque Tₐ=[T_{a,1}, . . . T_{a,N}]^{T} required for controlling and stabilizing the attitude of the current satellite is used as an input value, and a null vector Vi is calculated by using the wheel steering matrix C, and when the torque of the wheel that has reached the maximum momentum is Ta,i, the Tn,i value is selected such that Tcmd,i of the corresponding wheel becomes zero, and then a zero torque to be added to the wheel is calculated by:
Tₐ=−T_{a,i}·V Eq. (4)

5. The method of claim 4, wherein, in the step of calculating a torque inputted to the wheels by adding the zero torque of the wheel acquired by the step to the torque Ta required for the attitude control of the satellite, the reaction wheels are made to reach an optimum bias momentum state by using the input torque of the wheels calculated by the following equation (8):
$$\begin{matrix}{T}_{cmd} = {T}_{a} + {T}_{n} \\ = [ \begin{matrix}{T}_{a , 1} \\ {T}_{a , 2} \\ {T}_{a , 3} \\ {T}_{a , 4}\end{matrix} ] + [ \begin{matrix}- {T}_{a , 1} \\ + {T}_{a , 1} \\ - {T}_{a , 1} \\ + {T}_{a , 1}\end{matrix} ] \\ = [ \begin{matrix}0 \\ {T}_{a , 2} + {T}_{a , 1} \\ {T}_{a , 3} - {T}_{a , 1} \\ {T}_{a , 4} + {T}_{a , 1}\end{matrix} ]\end{matrix} \qquad Eq . ( 8 )$$

6. The method of claim 2, wherein, in the zero torque calculating step (S20), if the current speed and momentum reach a maximum value, a wheel torque Ta,i required for attitude control and stabilization of the satellite of the wheel whose speed and momentum has reached the maximum value is multiplied by a null space vector to generate a zero torque, and
the zero torque is added to a torque Ta required for attitude control to obtain a torque Tcmd inputted to the reaction wheels, to thereby calculate an optimum bias momentum.

7. The method of claim 6, wherein, in the zero torque generating step, a wheel torque Tₐ=[_{a,1}, . . . T_{a,N}]^{T} required for controlling and stabilizing the attitude of the current satellite is used as an input value, and a null vector Vi is calculated by using the wheel steering matrix C, and when the torque of the wheel that has reached the maximum momentum is Ta,i, the Tn,i value is selected such that Tcmd,i of the corresponding wheel becomes zero, and then a zero torque to be added to the wheel is calculated by:
Tₐ=−T_{a,i}·V Eq. (4)

8. The method of claim 7, wherein, in the step of calculating a torque inputted to the wheels by adding the zero torque of the wheel acquired by the step to the torque Ta required for the attitude control of the satellite, the reaction wheels are made to reach an optimum bias momentum state by using the input torque of the wheels calculated by the following equation (8):
$$\begin{matrix}{T}_{cmd} = {T}_{a} + {T}_{n} \\ = [ \begin{matrix}{T}_{a , 1} \\ {T}_{a , 2} \\ {T}_{a , 3} \\ {T}_{a , 4}\end{matrix} ] + [ \begin{matrix}- {T}_{a , 1} \\ + {T}_{a , 1} \\ - {T}_{a , 1} \\ + {T}_{a , 1}\end{matrix} ] \\ = [ \begin{matrix}0 \\ {T}_{a , 2} + {T}_{a , 1} \\ {T}_{a , 3} - {T}_{a , 1} \\ {T}_{a , 4} + {T}_{a , 1}\end{matrix} ]\end{matrix} \qquad Eq . ( 8 )$$
